(19) United States
(12) Patent Application Publication
(10) Pub. No.: US 2005/0226691 A1
(43) Pub. Date: Oct. 13, 2005

(54) Sintered body with high hardness for cutting cast iron and the method for producing same

(75) Inventors: Hee-Sub Park, Guro-gu (KR); Min-Ho Ryoo, Suwon-si (KR)

Correspondence Address: NELSON MULLINS RILEY & SCARBOROUGH, LLP, 1320 MAIN STREET, 17TH FLOOR, COLUMBIA, SC, 29201, US

(73) Assignee: ILJIN DIAMOND CO., LTD, Mapo-gu (KR)

(21) Appl. No.: 10/520,473

(22) PCT Filed: Jun. 18, 2003
(86) PCT No.: PCT/KR03/01202

§ 371 Date: Apr. 27, 2005

(30) Foreign Application Priority Data
Jul. 8, 2002 (KR) 10-2002-0039276

(51) Int. Cl. B26D 1/00

(52) U.S. Cl. 407/119

(57) ABSTRACT

Disclosed is a sintered body with high hardness for cutting cast iron, which contains cubic boron nitride(CBN), high pressure phase nitride. The sintered body of the present invention is prepared by sintering cubic boron nitride powder and powder of bonding materials on a WC/Co based hard substrate, and by forming hard layer of polycrystaline cubic boron nitride(PCBN). The bonding materials are two or more of materials selected from the group composed of titanium, aluminum and nickel, and carbide therof, nitride therof, boride therof and carbon nitride thereof, and mutual solid solution compound thereof. Volume fraction of the CBN in the PCBN hard layer is 80-98% by volume. By using the sintered body of the present invention it is possible to produce fine CBN powder with increased durability and themal stability, improving the physical property of the product.

### TECHNICAL FIELD

The present invention relates to a sintered body with high hardness. More particularly, the present invention relates to a sintered body with high hardness for use in the cutting of cast iron, which contains cubic boron nitride (hereinafter, referred to as “CBN”) as high-pressure phase boron nitride, and also to a method for producing the same.

### BACKGROUND ART

A diamond sintered body tool has high hardness and thus is an extremely excellent tool, but disadvantageously reacts with iron metal at high temperature. For this reason, it is unsuitable for the cutting of iron metal.

Meanwhile, high-pressure phase boron nitrides include single-crystalline cubic boron nitride synthesized by a catalyst, and polycrystalline wurtzite-type boron nitride synthesized under ultrahigh pressure shock caused by the explosion of an explosive. The high-pressure phase boron nitrides of such two types have the highest hardness next to diamond, and are particularly useful as a raw material for the production of a sintered body for abrasive, grinding and cutting tools.

Particularly, since CBN shows low reactivity with iron-based metals, and has high conductivity and the highest hardness next to diamond, it is an excellent cutting tool material that can be used as substitute for diamond.

To use CBN for a cutting tool, CBN powders must be sintered to make polycrystalline cubic boron nitride (hereinafter, referred to as “PCBN”). However, CBN is a metastable phase that is stable at high pressure but transformed into hexagonal boron nitride having extremely deteriorated mechanical properties at normal pressure and high temperature. For this reason, ultrahigh pressure is necessarily required in a process of sintering CBN. Moreover, CBN is a material having a typical covalent bond, and thus, suitable binders needs to be added.

Currently commercialized PCBN (e.g., DZN 6,000 manufactured by GE Co.) for cast iron cutting contains about 90% by volume of CBN, and as binders, an aluminum (Al)-based compound, and cobalt, tungsten or compounds of such elements that are diffused from a matrix metal. However, as the content (vol %) of CBN in PCBN is increased, the abrasion resistance of a tool is increased, but it is difficult to densely sinter CBN only with the above-mentioned binders and thus there is a limitation in increasing the content of CBN.

Furthermore, due to a limitation in increasing the hardness or abrasion resistance of a high hardness layer of PCBN only with the above-mentioned binders, in the case of severe cutting conditions, such as the cutting of high strength cast iron or the high speed cutting of gray cast iron, the abrasion of a tool edge is rapidly progressed to shorten the life cycle of a tool. Also, in the case of such severe cutting conditions, the crater wear of the tool edge occurs due to high heat generated during a cutting process so that the tool edge is broken. Thus, in PCBN with the above-mention binders, there are problems in view of abrasion resistance or thermal stability.

Meanwhile, the smaller the size of CBN particles, the better the roughness of the cast iron surface to be cut, and thus, the size of CBN particles in a high hardness layer of PCBN needs to be reduced for the quality of a material to be cut. However, PCBN according to the prior art is sintered by the so-called “infiltration phenomenon” that cobalt is diffused into the space between CBN particles. In the case where the CBN particles have small particle size, the size of the space between the CBN particles into which cobalt can be diffused will be reduced. For this reason, the size of the CBN particles that can be sintered was limited to a size larger than that for suitable sintering, i.e., a size larger than 10 μm.

### DISCLOSURE OF INVENTION

Accordingly, the present invention has been made to solve the above-mentioned problems occurring in the prior art, and an object of the present invention is to provide a sintered body with high hardness for use in the cutting of cast iron, which is produced by adding suitable binders, such as a titanium-based compound, to CBN and sintering the mixture, and thus has excellent abrasion resistance and thermal stability.

Another object of the present invention is to provide a sintered body having high hardness, which comprises a high hardness layer of PCBN having a finer particle size by virtue of the sintering capability of the binders.

To achieve the above-mentioned objects, in one aspect, the present invention provides a sintered body with high hardness for use in the cutting of cast iron, which comprises a WC/Co-based superhard substrate, and a high hardness layer of polycrystalline cubic boron nitride (PCBN) formed by sintering cubic boron nitride (CBN) and binder powders on the WC/Co-based superhard substrate, in which the binders are two or more materials selected from the group consisting of titanium, aluminum and nickel, and carbides, nitrides, borides and carbonitrides thereof and a solid solution between two or more of the metal materials, and the content of CBN in the high hardness layer of PCBN is in the range of 80 to 98% by volume.

Preferably, the size of CBN particles contained in the high hardness layer of PCBN is 2-6 μm.

Furthermore, the binders contained in the high hardness layer of PCBN preferably comprise a titanium-based compound, an aluminum-based compound and a nickel-based compound, which are present at 3-20% by volume, 10-30% by volume and 5-20% by volume, respectively, relative to the volume of the binders.

Moreover, the high hardness layer of PCBN preferably contains cobalt and tungsten compounds diffused from the superhard substrate, at 30-45% by volume and 20-40% by weight, respectively, relative to the volume of the binders.

In addition, the content of cobalt in the superhard substrate is 10-16% by weight.

In another aspect, the present invention provides a method for producing a sintered body with high hardness, which comprises the steps of: providing a WC/Co-based superhard substrate, cubic boron nitride (CBN) powders, and binder powders consisting of two or more materials selected from the group consisting of titanium, aluminum and nickel, and carbides, nitrides, borides and carbonitrides thereof and a solid solution between the metal materials; mixing the binder powders and the CBN powders to make a powder mixture; heating the powder mixture to remove impurities; and sintering the heated powder mixture on the superhard substrate to form a high highness layer of polycrystalline cubic boron nitride (PCBN) on the substrate.

In the method according to the present invention, the sintering step is preferably carried out under a pressure of 5-7 GPa at a temperature of 1300-1600° C.

Hereinafter, the present invention will be described in detail.

The present invention has a main characteristic in that titanium and aluminum, etc., binder phases making CBN particles more densely bond, are used as binders to greatly increase the content (vol %) of CBN in the high hardness layer of PCBN.

Titanium serves to improve the reactivity between the CBN particles to make the CBN particles more strongly bond to each other, thereby maximizing the content of CBN. Moreover, titanium reacts with a nitrogen or boron atom contained in CBN upon ultrahigh pressure sintering to form a strong bond with the CBN particles. This improves the strength of a sintered body while forming a new titanium nitride, boride, carbide and carbonitride. Such reaction products impart thermal resistance and oxidation resistance to the sintered body such that the sintered body has high temperature stability, and thus, the edge of a tool made of the sintered body can resist high temperature caused by the cutting of cast iron, etc.

Aluminum or an aluminum-based compound, such as aluminum nitride or boride, as a binder, also acts as a binder phase making the CBN particles strongly bond to each other.

In addition to the compounds as described above, nickel or a nickel-based compound can be added to make sintering denser. This is because nickel has good wettability for the binders such that sintering is progressed smoothly and densely and the brittleness of the sintered body is reduced.

According to the present invention, titanium, the titanium-based compound, aluminum, the aluminum-based compound, nickel or the nickel-based compound is added so that the content of CBN in the high hardness layer of PCBN can be increased to 98% by volume.

Meanwhile, if the content of CBN in the high hardness layer of PCBN is less than 80% by volume, the abrasion resistance of the sintered body will be greatly reduced, and if the content of CBN in the high hardness layer of PCBN is more than 98% by volume, the binding between the CBN particles and the binders will be insufficient to reduce the abrasion resistance of the sintered body. Thus, it is preferred that the content of CBN in high hardness layer of PCBN is 80-98% by volume.

Moreover, the titanium-based compound, the aluminum-based compound or the nickel-based compound as a binder makes CBN more densely bonds together with cobalt and tungsten carbide diffused from the superhard substrate, and also causes the titanium-based compound and the like to form new compounds, such as carbides, nitrides, carbonitrides or borides. This allows even CBN powders having a smaller particle size (i.e., size smaller than 10 μm) than the prior sintered body to be sintered. Namely, since the binders of the present invention have a superior sintering property to the prior cobalt-based binder, even finer particles having a small space therebetween into which cobalt can diffuse can be sintered.

However, if the size of CBN particles is less than 2 μm, the abrasion resistance of the sintered body will be rapidly reduced since the particle size is excessively small. On the other hand, if the size of CBN particles exceeds 6 μm, the diffusion of cobalt from the superhard substrate will become better, but the bonding force of titanium and the like bonded around the CBN particles will be weakened to reduce the abrasion resistance of the sintered body, thereby causing tool damage.

Thus, it is preferred that the particle size of CBN particles is in the range of 2-6 μm.

To obtain the above-mentioned effects using the titanium-based compound, the content of the titanium-based compound in the high hardness layer of PCBN needs to be more than 3% by volume. If the titanium-based compound is excessively present in the high hardness layer of PCBN, the brittleness of the sintered body will be increased. Thus, it is preferred that the content of the titanium-based compound in the high hardness layer of PCBN is less than 20% by volume.

Also, if the aluminum-based compound is contained at a larger amount than an acceptable amount, the brittleness and abrasion resistance of the sintered body will be reduced together. Thus, it is preferred that the content of the aluminum-based compound in the high hardness layer of PCBN is 10-30% by volume.

In order to progress sintering smoothly and densely and reduce the brittleness of the sintered body, it is preferred that nickel or a compound thereof is contained in the high hardness layer of PCBN at more than 5% by volume. However, if the content of nickel exceeds 20% by volume, the abrasion resistance of the sintered body will be rapidly reduced, and thus, it is preferred that nickel is contained at an amount smaller than 20% by volume.

Meanwhile, cobalt contained in the superhard substrate, a matrix, is dissolved during high temperature and high pressure sintering and rapidly diffused between the CBN particles and the binders. This liquid cobalt acts as a diffusion pathway so that tungsten carbide is also diffused between the CBN particles and the binders, thereby improving the abrasion resistance and impact resistance of the sintered body.

However, if cobalt and tungsten carbide are diffused at an excessive amount, the content of the titanium-, aluminum- and nickel-based compounds will be relatively reduced to decrease the abrasion resistance of the sintered body. Thus, it is preferred that the content of cobalt and tungsten carbide are present at 30-45% by volume and 20-40% by volume, respectively.

In order to keep cobalt and tungsten carbide at the above-mentioned content, it is preferred that the content of cobalt in the superhard substrate is 10-16% by weight.

Hereinafter, the method for producing the sintered body with high hardness will be described in detail.

First, a WC/Co-based superhard substrate, cubic boron nitride (CBN) powders, and binder powders consisting of two or more materials selected from the group consisting of titanium, aluminum and nickel, and carbides, nitrides, borides and carbonitrides thereof and a solid solution between the metal materials, are provided.

The binder powders and the CBN powders are mixed with each other by a method such as ball milling, etc., and then heated under a reducing atmosphere to remove water and impurities from the surface.

The powder mixture produced by the above-mentioned step are applied on the WC/Co-based superhard substrate to a given thickness, and sintered at high temperature under high pressure to form a high hardness layer of polycrystalline cubic boron nitride (PCBN) on the substrate.

In order to form the sintered body more densely, the sintering is preferably carried out at a high pressure of 5-7 GPa and a high temperature of 1,300-1,600° C.

In the sintering step, the binder which became a liquid phase bonds around the CBN particles or causes the CBN particles to bond to each other. Moreover, cobalt and tungsten carbide in the superhard substrate infiltrate between the CBN powders by a capillary phenomenon.

According to the present invention, the binder having excellent reactivity with CBN is used, and thus, fast migration of boron and nitrogen atoms occurs by the liquid phase binder infiltrated at the operation conditions, so that the CBN particles can be strongly bonded to each other.

### BRIEF DESCRIPTION OF DRAWINGS

FIG. 1 is a photograph taken at 1,000× magnification for the texture and structure of a sintered body with high hardness according to the present invention; and

FIG. 2 is a graph showing the result of phase analysis by X-ray diffraction analysis of a sintered body with high hardness according to the present invention.

### BEST MODE FOR CARRYING OUT THE INVENTION

Hereinafter, preferred examples of the present invention will be described in detail with reference to the accompanying drawings.

### EXAMPLE 1

CBN powders having an average particle size of 3 μm, titanium-based compound powders, aluminum-based compound powders and nickel metal powders, were charged into a container made of a superhard material, and wet-mixed using balls of a superhard material.

The powder mixture was heated at 1,000° C. for 6 hours under a hydrogen atmosphere to remove water and impurities from the surface. Next, the heated powder mixture was applied on a WC-13 wt % Co superhard substrate, and then, sintered at 1,400° C. under 5 GPa using pyrophyllite as a pressure medium, and a graphite cylinder as a heater.

The high hardness layer of PCBN in the sintered body produced as described above was ground flat with a diamond whetstone, and further ground with fine diamond particles.

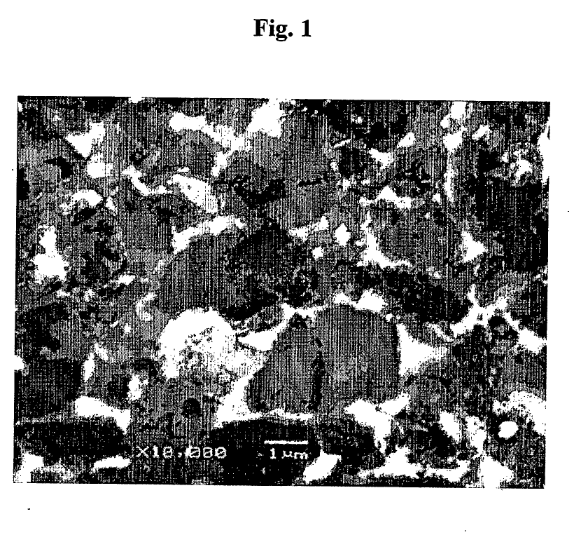

The ground surface of the sintered body was observed with an electron microscope and thus found to have a texture and structure as shown in FIG. 1. As shown in FIG. 1, black particles are CBN particles bonded to each other, and the remaining portion is filled with the binder.

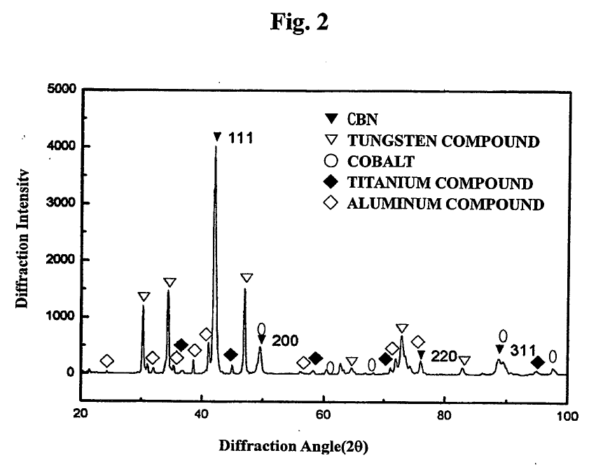

The high hardness layer of PCBN in the sintered body produced as described above was examined with an X-ray diffractometer. The examined result is shown in FIG. 2. As shown in FIG. 2, it could be found that, in the high hardness layer of PCBN, there were titanium nitride and boride, aluminum boride and nitride, and cobalt and tungsten carbide diffused from the superhard substrate.

Cast iron cutting tools were produced from sintered bodies produced as described above. The cutting tools were evaluated for their abrasion resistance by wet-cutting GC250 cast iron with such a cutting tool at a cutting rate of 1,200 mm/min, a cutting depth of 0.25 mm and a feed rate of 0.1 mm/rev for 10 minutes. The evaluated results are given in Table 1 below.

TABLE 1

| | | Ti | | | | | |
|---|---|---|---|---|---|---|---|
| | | com- | | | | | |
| | | pound | Al | Ni | W | Co | |
| | | (vol % | compound | (vol % | compound | (vol % | Tool |
| Sam- | CBN | relative | (vol % | relative | (vol % | relative | abra- |
| ple | (vol | to | relative to | to | relative to | to | sion |
| No. | %) | binders) | binders) | binders) | binders) | binders) | (mm) |
| 1 | 75 | 5 | 15 | 10 | 30 | 40 | 0.62 |
| 2 | 80 | 5 | 15 | 10 | 30 | 40 | 0.39 |
| 3 | 85 | 5 | 15 | 10 | 30 | 40 | 0.37 |
| 4 | 90 | 5 | 15 | 10 | 30 | 40 | 0.31 |
| 5 | 95 | 5 | 15 | 10 | 30 | 40 | 0.28 |
| 6 | 99 | 5 | 15 | 10 | 30 | 40 | 0.65 |
| 7 | 93 | 10 | 15 | 10 | 25 | 40 | 0.27 |
| 8 | 93 | 20 | 15 | 10 | 20 | 35 | 0.3 |
| 9 | 95 | 8 | 13 | 7 | 34 | 38 | 0.26 |
| 10 | 95 | 10 | 15 | 0 | 35 | 40 | 0.46 |
| 11 | 96 | 9 | 35 | 13 | 16 | 27 | Dam- |
| | | | | | | | age |
| 12 | 96 | 8 | 13 | 26 | 22 | 31 | 0.52 |

As indicated in Table 1, it could be found that, as the content (vol %) of CBN was increased, abrasion resistance was increased. However, in the case where the volume % of CBN was 75% by volume (sample No. 1), tool abrasion was greatly increased. Where the content of CBN was 99% (sample No. 6), tool abrasion was also greatly increased since the amount of CBN was too much as compared to the binder amount.

Furthermore, where the content of the aluminum-based compound was an excessive content of 35% by volume (sample No. 11), brittleness was increased but abrasion resistance was reduced. In the case of sample No. 11, since the amount of the tungsten compound and cobalt was smaller than a suitable amount, tool damage occurred.

In addition, in the case where the nickel-based compound was contained (sample No. 10) or it was excessively contained (sample No. 12), abrasion resistance was reduced.

### EXAMPLE 2

Sintered bodies were produced in the same manner as in Example 1 except that the composition of the sintered bodies varied as indicated in Table 2 below. Furthermore, cast iron cutting tools were produced from such sintered bodies, and evaluated for their abrasion resistance by wet-cutting GCD400 cast iron with such tools at a cutting rate of 400 mm/min, a cutting depth of 0.2 mm and a feed rate of 0.1 mm/rev for 5 minutes.

TABLE 2

| | | Ti | | | | | |
|---|---|---|---|---|---|---|---|
| | | com- | | | | | |
| | | (vol % | Al | Ni | W | Co | |
| | | pound | compound | (vol % | compound | (vol % | Tool |
| Sam- | CBN | relative | (vol % | relative | (vol % | relative | abra- |
| ple | (vol | to | relative to | to | relative to | to | sion |
| No. | %) | binders) | binders) | binders) | binders) | binders) | (mm) |
| 13 | 90 | 8 | 13 | 7 | 31 | 41 | 0.23 |
| 14 | 92 | 30 | 10 | 8 | 20 | 32 | 0.52 |
| 15 | 92 | 0 | 10 | 8 | 38 | 44 | 0.67 |
| 16 | 95 | 7 | 12 | 8 | 33 | 40 | 0.26 |
| 17 | 96 | 9 | 15 | 6 | 32 | 38 | 0.35 |

| | | |
|---|---|---|
| 18 | Commercial sintered body containing Co binder | 0.53 |

It could be found that, where the titanium-based compound exceeded 20% by volume or was not contained as in sample Nos. 14 and 15 of Table 2, tool abrasion was greatly increased.

Meanwhile, the comparison between the tool abrasion of the Co binder-containing sintered body according to the prior art and the sintered body according to the present invention showed that the sintered body of the present invention had 1.5-2.5 times better abrasion resistance than the sintered body of the prior art.

### EXAMPLE 3

CBN powders having an average particle size of 1 μm, 3 μm, 6 μm or 10 μm, titanium-based compound powders, aluminum-based compound powders and nickel metal powders were charged into a container made of a superhard material, and wet-mixed using balls made of a superhard material.

The powder mixture was heated at 1,000° C. for 6 hours under a hydrogen atmosphere to remove water and impurities from the surface. Next, the heated powder mixture was applied on a WC-13 wt % superhard substrate, and then sintered at 1,500° C. under 5 GPa using pyrophyllite as a pressure medium, and a graphite cylinder as a heater, thereby obtaining sintered bodies.

Cast iron cutting tools were produced from such sintered bodies. These cutting tools were evaluated for their abrasion resistance by wet-cutting GC250 cast iron with such cutting tools at a cutting rate of 800 mm/min, a cutting depth of 0.5 mm and a feed rate of 0.1 mm/rev for 10 minutes. The evaluated results are given in Table 3 below.

TABLE 3

| | | | Ti | Al | Ni | W | Co | |
|---|---|---|---|---|---|---|---|---|
| | | CBN | compound | compound | (vol % | compound | (vol % | |
| | | particle | (vol % | (vol % | relative | (vol % | relative | Tool |
| Sample | CBN | size | relative to | relative to | to | relative to | to | abrasion |
| No. | (vol %) | (μm) | binders) | binders) | binders) | binders) | binders) | (mm) |
| 19 | 95 | 1 | 6 | 12 | 7 | 34 | 41 | 0.53 |
| 20 | 95 | 3 | 6 | 12 | 7 | 34 | 41 | 0.25 |
| 21 | 95 | 6 | 6 | 12 | 7 | 34 | 41 | 0.36 |
| 22 | 95 | 10 | 6 | 12 | 7 | 34 | 41 | Damage |

As indicated in Table 3, in the case where the particle size of CBN was 1 μm (sample No. 19) or 10 μm (sample No. 22), tool abrasion occurred rapidly or tool damage occurred because the binders did not form a strong bond with CBN particles.

### EXAMPLE 4

CBN powders having an average particle size of 3 μm, titanium-based compound powders, aluminum-based compound powders and nickel metal powders were charged into a container made of a superhard material, and wet-mixed using balls made of a superhard material.

The powder mixture was heated at 1,000° C. for 6 hours under a hydrogen atmosphere to remove water and impurities from the surface. Next, the heated powder mixture was applied on superhard substrates each containing 6, 10, 13, 16 and 20% by weight of cobalt, and then sintered at 1,500° C. under 5 GPa using pyrophyllite as a pressure medium, and a graphite cylinder as a heater, thereby obtaining sintered bodies as indicated in Table 4 below.

Cast iron cutting tools were produced from this sintered body. These cutting tools were evaluated for their abrasion resistance by wet-cutting GC250 cast iron with such cutting tools at a cutting rate of 800 nun/min, a cutting depth of 0.5 mm and a feed rate of 0.1 mm/rev for 10 minutes.

TABLE 4

| | | Content | | | | | | |
|---|---|---|---|---|---|---|---|---|
| | | of cobalt | Ti | Al | Ni | W | Co | |
| | | in | compound | compound | (vol % | compound | (vol % | |
| | | superhard | (vol % | (vol % | relative | (vol % | relative | Tool |
| Sample | CBN | substrate | relative to | relative to | to | relative to | to | abrasion |
| No. | (vol %) | (wt %) | binders) | binders) | binders) | binders) | binders) | (mm) |
| 23 | 90 | 6 | 19 | 26 | 17 | 15 | 23 | Damage |
| 24 | 90 | 10 | 10 | 15 | 9 | 30 | 36 | 0.24 |
| 25 | 90 | 13 | 6 | 11 | 6 | 35 | 42 | 0.26 |
| 26 | 90 | 16 | 5 | 10 | 6 | 36 | 43 | 0.28 |
| 27 | 90 | 20 | 3 | 9 | 4 | 38 | 46 | 0.52 |

As indicated in Table 4, in the case where the content of cobalt in the superhard substrate was 6% by weight (sample No. 6), tool damage occurred because the content of cobalt in the high hardness layer of PCBN was lower than an acceptable level. Moreover, in the case where the content of cobalt in the superhard substrate was 20% by weight (sample No. 20), tool abrasion was rapidly increased because the content of cobalt in the high hardness layer of PCBN was higher than 45% by volume.

### INDUSTRIAL APPLICABILITY

As described above, in the sintered body with high hardness according to the present invention, two or more compounds selected from the titanium-based compound, the aluminum-based compound and the nickel-based compound, are added as binders, so that the abrasion resistance and thermal stability of the sintered body are greatly improved.

Furthermore, the present invention allows fine CBN powders to be sintered, so that the quality of a material to be cut is improved.

1-7. (canceled)

8. A sintered body with high hardness for use in the cutting of cast iron, which comprises a WC/Co-based superhard substrate, and a high hardness layer of polycrystalline cubic boron nitride (PCBN) formed by sintering cubic boron nitride (CBN) and binder powders on the WC/Co-based superhard substrate, in which the binders are two or more materials selected from the group consisting of titanium, aluminum and nickel, and carbides, nitrides, borides and carbonitrides thereof and a solid solution between two or more of the metal materials, and the content of CBN in the high hardness layer of PCBN is in the range of 80 to 98% by volume.

9. The sintered body of claim 8, wherein the size of CBN particles contained in the high hardness layer of PCBN is 2-6 μm.

10. The sintered body of claim 8, wherein the binders contained in the high hardness layer of PCBN comprises a titanium-based compound, an aluminum-based compound and a nickel-based compound, which are present at 3-20% by volume, 10-30% by volume and 5-20% by volume, respectively, relative to the volume of the binders.

11. The sintered body of claim 8, wherein the high hardness layer of PCBN contains cobalt and tungsten compounds diffused from the superhard substrate, at 30-45% by volume and 20-40% by weight, respectively, relative to the volume of the binders.

12. The sintered body of claim 9, wherein the binders contained in the high hardness layer of PCBN comprises a titanium-based compound, an aluminum-based compound and a nickel-based compound, which are present at 3-20% by volume, 10-30% by volume and 5-20% by volume, respectively, relative to the volume of the binders.

13. The sintered body of claim 9, wherein the high hardness layer of PCBN contains cobalt and tungsten compounds diffused from the superhard substrate, at 30-45% by volume and 20-40% by weight, respectively, relative to the volume of the binders.

14. The sintered body of claim 11, wherein the content of cobalt in the superhard substrate is 10-16% by weight.

15. The sintered body of claim 13, wherein the content of cobalt in the superhard substrate is 10-16% by weight.

16. A method for producing a sintered body with high hardness for use in the cutting of cast iron, which comprises the steps of:
providing a WC/Co-based superhard substrate, cubic boron nitride (CBN) powders, and binder powders consisting of two or more materials selected from the group consisting of titanium, aluminum and nickel, and carbides, nitrides, borides and carbonitrides thereof and a solid solution between two or more of the metal materials;
mixing the binder powders and the CBN powders to make a powder mixture;
heating the powder mixture to remove impurities; and
sintering the heated powder mixture on a superhard substrate to form a high highness layer of polycrystalline cubic boron nitride (PCBN) on the superhard substrate.

17. The method of claim 16, wherein the sintering step is carried out under a pressure of 5-7 GPa at a temperature of 1300-1600° C.
